(19) United States
(12) Patent Application Publication
(10) Pub. No.: US 2002/0198988 A1
(43) Pub. Date: Dec. 26, 2002

(54) Communication monitoring system in which monitoring server is connected with network

(76) Inventor: Takuya Hirose, Tokyo (JP)

Correspondence Address: WHITHAM, CURTIS & CHRISTOFFERSON, P.C., 11491 SUNSET HILLS ROAD, SUITE 340, P.O. BOX 9204, RESTON, VA, 20190, US

(21) Appl. No.: 10/167,483

(22) Filed: Jun. 13, 2002

(30) Foreign Application Priority Data
Jun. 22, 2001 (JP) 190429/2001

(51) Int. Cl. G06F 15/173

(52) U.S. Cl. 709/224; 714/40

(57) ABSTRACT

A communication monitoring system is comprised of a semiconductor device manufacturing apparatus connected with a network, a host computer connected with the network, and a monitoring unit connected with the network. The semiconductor device manufacturing apparatus and the host computer carry out a sequence of communications through the network about a process of the semiconductor device manufacturing apparatus. The monitoring unit takes therein a first set of packets of the first sequence of communications and a second set of packets of the second sequence of communications through the network between the semiconductor device manufacturing apparatus and the host computer, and determines whether the communication between of the semiconductor device manufacturing apparatus and the host computer is normal or defective, based on the packets of the first and second sets.

### BACKGROUND OF THE INVENTION

1. Field of the Invention

The present invention relates to a communication monitoring system and a monitor server used in the communication monitoring system.

2. Description of the Related Art

A conventional example of a communication monitoring system 50 is shown in FIG. 1. Referring to FIG. 1, the communication monitoring system 50 is composed of a host computer 51 connected with an Ethernet 53, a plurality of semiconductor device manufacturing apparatuses 52 connected with the Ethernet 53. The host computer controls the plurality of semiconductor device manufacturing apparatuses 52 in the remote while carrying out communication with the semiconductor device manufacturing apparatuses 52. Also, the host computer 51 can collect process data of each of the semiconductor device manufacturing apparatuses 52, and can hold real-time communication records.

The semiconductor device manufacturing apparatus 52 processes a lot of wafers based on instructions from the host computer 51. The semiconductor device manufacturing apparatus 52 reports the process result as the process data to the host computer 51.

An operation procedure in the communication monitoring system 50 is shown below.

\mathring{1} The host computer 51 holds communication records with the semiconductor device manufacturing apparatus 52.

\mathring{2} When a communication fault occurs, a technical expert collects the communication records held by the host computer 51.

\mathring{3} The technical expert compares the communication records collected in the above \mathring{2} and the specification, checks a defective part and analyzes content.

According to above-mentioned communication monitoring system 50, when the host computer 51 is downed, it is not possible to analyze the fault content using the communication records. Also, the analysis takes very long time even if the analysis is carried out by another method. This is because only the host computer 51 can take the communication records with the semiconductor device manufacturing apparatus 52 as a communication end. Also, although the real-time communication records exists at the host computer 51, it is impossible to investigate the communication records, when the host computer 51 has been downed.

Also, when the host computer 51 is downed, a log file (record file) necessary to analyze the communication records is not left sometimes. This is because there is a limitation on a memory capacity of the host computer 51.

To improve reliability of the host computer 51, the measure of duplicating about all the components of the host computers 51 becomes necessary, resulting in very high cost.

In conjunction with the above description, a network analysis apparatus is disclosed in Japanese Laid Open Patent Application (JP-P2000-196671A). In this reference, the network analysis apparatus is comprised of a plurality of input/output ports such as terminals. The network analysis apparatus has a network connection function to relay packets between equipments connected with these input/output ports and network connection apparatuses, and a determination function to carry out a determination of an optimal relay system and transmission rate from the results of the packet relay.

Also, a fault state change accumulating apparatus is disclosed in Japanese Laid Open Patent application (JP-A-Heisei 9-292916). In this reference, the fault state change accumulating apparatus is comprised of a state change buffer and a state change processing section. The state change buffer temporarily buffers stage change packets supplied through an interface, for some time period. The state change processing section inputs the state change packets buffered in the state change buffer and carries out an analyzing operation. A fault state change record storing section recognizes as fault association state change, the state change packets previously buffered in the state change buffer by a predetermined time from now and stores the fault association state change, when a fault factor state change is detected.

Also, a network monitoring apparatus is disclosed in Japanese Laid Open Patent Application (JP-A-Heisei 7-321783). In this reference, the network monitoring apparatus is connected with a network, to receive and analyze a data frame transmitted to the network. The network monitoring apparatus is comprised of first selection process means for selecting desired one of the data frames. First memory means stores the selection result of the first selection process means. Protocol analysis means analyzes the header of the data frame stored in the first memory means, and outputs an analysis result and data on an application layer subsequent to the header. Second selection process means estimates the data format of the data on the application layer obtained by the protocol analysis means and selects data of a necessary data format. Second memory means stores the selection result of the second selection process means and necessary data of the analysis result corresponding to the selection result.

Also, a monitoring system is disclosed in Japanese Laid Open Patent Application (JP-P2000-194625A). In this reference, the monitoring system monitors a plurality of segments connected with a network. The monitoring system includes a terminal agent which is comprised of monitor means and transmission means. The monitor means is provided in each segment where packets can be transmitted or received with a protocol, to monitor packets in the segment. The transmission means writes data collected by the monitor means in the packet corresponding to the protocol with which the packet can be transmitted through the segment to the segment where a server exists, and transmits the packet to the server. The packets transmitted by the transmission means are received and aggregated to analyze the data.

Also, a network security management system is disclosed in Japanese Laid Open Patent Application (JP-A-Heisei 8-172433). In this reference, the network security management system has a table for storing an address of each of apparatuses connected. with a network. Packet collection means collects packets transmitted on the network. Distinction means distinguishes whether or not the address of each packet collected by the packet collection means is stored on the table. Thus, the unjust use of the network is discovered from the packet that the address is not stored on the table.

### SUMMARY OF THE INVENTION

Therefore, an object of the present invention is to provide a communication monitoring system and a monitor server which can detect a communication fault with a semiconductor device manufacturing apparatus, even if a host computer is downed.

Another object of the present invention is to provide a communication monitoring system and a monitor server which can detect a fault of a host computer, regardless of the state of a host computer.

Another object of the present invention is to provide a communication monitoring system and a monitor server unit which can detect a communication fault between a host computer and a semiconductor device manufacturing apparatus in a simple technique.

Another object of the present invention is to provide a communication monitoring system and a monitor server unit which can detect a communication fault between a host computer and a semiconductor device manufacturing apparatus without many work steps.

Another object of the present invention is to provide a communication monitoring system and a monitor server unit which can detect a fault of a communication sequence, a data format or data in communication between a host computer and a semiconductor device manufacturing apparatus.

Another object of the present invention is to provide a communication monitoring system and a monitor server unit which can continue subsequent communication when a host computer does not carry out a reception operation in a normal communication.

In an aspect of the present invention, a communication monitoring system is comprised of a semiconductor device manufacturing apparatus connected with a network, a host computer connected with the network, and a monitoring unit connected with the network. The semiconductor device manufacturing apparatus and the host computer carry out a sequence of communications through the network about a process of the semiconductor device manufacturing apparatus. The monitoring unit takes therein a first set of packets of the first sequence of communications and a second set of packets of the second sequence of communications through the network between the semiconductor device manufacturing apparatus and the host computer, and determines whether the communication between of the semiconductor device manufacturing apparatus and the host computer is normal or defective, based on the packets of the first and second sets.

Here, the monitoring unit may compare an order of the packets of the first set and an order of the packets of the second set and determine whether the communication between of the semiconductor device manufacturing apparatus and the host computer is normal or defective, based on the comparison result of the order of the packets of the first set and the order of the packets of the second set.

In this case, when a first one of the packets of the second set which is transmitted from the semiconductor device manufacturing apparatus to the host computer in the second sequence of communications is determined to be normal but has been not received by the host computer, the monitoring unit may instruct the host computer to receive a second one of the packets of the second set which is transmitted from the semiconductor device manufacturing apparatus to the host computer in the second sequence of communications through the network, immediately after the transmission of the first packet. Also, the monitoring unit may further instruct the host computer to continue subsequent communications of the second sequence to the reception of the second packet.

Also, the monitoring unit may determine that the communication from one of the semiconductor device manufacturing apparatus and the host computer to the other is defective, when the first packet is transmitted from one of the semiconductor device manufacturing apparatus and the host computer to the other and then a third one, next to the first packet, of the packets of the second set is not transmitted from the other to the one through the network within a predetermined time from the transmission of the first packet.

Also, each of the packets of the second set may have a communication header containing an address of one of the semiconductor device manufacturing apparatus and the host computer as a source address and an address of the other as a destination address, and an apparatus ID for the semiconductor device manufacturing apparatus. The monitoring unit determines that the communication from one of the semiconductor device manufacturing apparatus and the host computer to the other is defective, when one of the source address and the destination address corresponding to the semiconductor device manufacturing apparatus does not correspond to the apparatus ID.

Also, each of the packets of the second set may have a communication header containing an address of one of the semiconductor device manufacturing apparatus and the host computer as a source address and an address of the other as a destination address, and an apparatus ID for the semiconductor device manufacturing apparatus. The monitoring unit determines that the communication from the host computer to the semiconductor device manufacturing apparatus is defective, when the destination addresses are not coincident with each other among the packets from the host computer to the semiconductor device manufacturing apparatus.

Also, each of the packets of the second set may have a communication header, an apparatus ID for the semiconductor device manufacturing apparatus, and a carrier ID of a carrier in which semiconductor wafers are accommodated. The monitoring unit determines that the communications of the second sequence are defective, when the carrier IDs are not coincident with each other among the packets of the second set.

Some of the packets of the second set may have a wafer ID in addition to the communication header, the apparatus ID, and the carrier ID. The monitoring unit determines that the communications of the second sequence are defective, when the wafer IDs are not coincident with each other among the some packets of the second set.

Also, each of the communications of the second sequence may be carried out in accordance with one of predetermined data formats. The monitoring unit determines that the sequence of the communications is defective, when data formats are not coincident with each other between corresponding two of the communications of the second sequence.

Also, the monitoring unit may store the first set of the packets of the first sequence of the communications and discard the second set of the packets of the second sequence of the communications, after it is determined that the second sequence of the communications is normal.

Instead, the monitoring unit may store the first set of the packets of the first sequence of the communications, and update each of the packets of the first set by a corresponding one of the packets of the second set of the second sequence of the communications, after it is determined that the second sequence of the communications is normal.

Also, it is desirable that the communication between the semiconductor device manufacturing apparatus and the host computer is of HSMS (HIGH-SPEED SECS MESSAGE SERVICES) communication based on the SEMI standard.

### BRIEF DESCRIPTION OF THE DRAWINGS

FIG. 1 is a block diagram showing the system configuration of a conventional communications system;

FIG. 2 is a block diagram showing the system configuration of a communication monitoring system according to an embodiment of the present invention;

FIG. 3 is a sequence diagram showing a communication sequence between a host computer and a semiconductor device manufacturing apparatus in the communication monitoring system according to the embodiment of the present invention;

FIG. 4 is a diagram showing a data format used in the communication between the host computer and the semiconductor device manufacturing apparatus in the communication monitoring system according to the embodiment of the present invention;

FIG. 5 is a diagram showing another data format used in the communication between the host computer and the semiconductor device manufacturing apparatus in the communication monitoring system according to the embodiment of the present invention;

FIG. 6 is a flow chart showing an example of the operation of an HSMS network monitoring apparatus in the communication monitoring system according to the embodiment of the present invention; and

FIG. 7 is a flow chart showing another example of the operation of the HSMS network monitoring apparatus in the communication monitoring system according to the embodiment of the present invention.

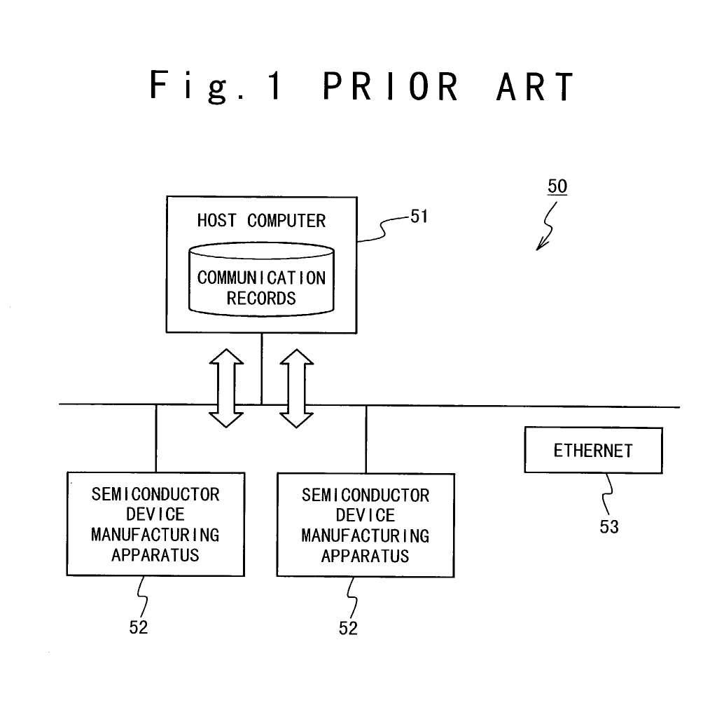

### DESCRIPTION OF THE PREFERRED EMBODIMENTS

Hereinafter, a communication monitoring system of the present invention will be described with reference to the attached drawings.

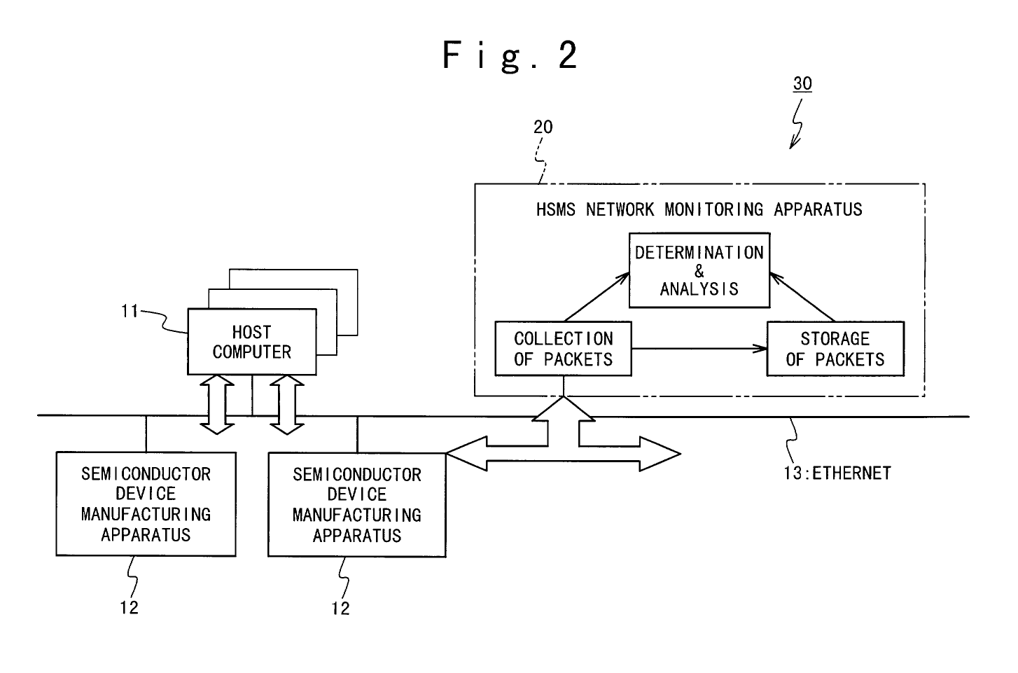

FIG. 2 shows the system configuration of the communication monitoring system according to an embodiment of the present invention. Referring to FIG. 2, the communication monitoring system 30 in the embodiment is comprised of a host computer 11, semiconductor device manufacturing apparatuses 12, an Ethernet 13 and a HSMS network monitoring apparatus 20.

The host computer 11 is connected with each of the semiconductor device manufacturing apparatuses 12 via the Ethernet 13, to carry out HSMS communication. Through the HSMS communication, the host computer 11 controls the semiconductor device manufacturing apparatus 12 online and collects process data of the semiconductor device manufacturing apparatus 12.

The semiconductor manufacture apparatus 12 has an apparatus controller (not shown). The semiconductor manufacture apparatus 12 is connected with the host computer 11 via the Ethernet 13, and processes a lot or wafers based on operation instructions from the apparatus controller which receives instructions from the host computer 11. The semiconductor manufacture apparatus 12 notifies a processing result of the lot as the process data to the host computer 11.

The HSMS network monitoring apparatus 20 takes therein all of HSMS communication packets in the communication between the host computer 11 and the semiconductor device manufacturing apparatus 12 via the Ethernet 13, and stores the taken-in data. The HSMS network monitoring apparatus 20 can carry out fault detection and analysis when a fault has occurred in the communication between the host computer 11 and the semiconductor device manufacturing apparatus 12.

In the communication monitoring system 30, a plurality of host computers 11 may be connected with the plurality of the semiconductor device manufacturing apparatuses 12 via the single Ethernet 13. Also, the single HSMS network monitoring apparatus 20 is connected with the Ethernet 13. Also, in the communication monitoring system 30, there is no case that one semiconductor device manufacturing apparatus 12 is connected with the plurality of host computers 11. The single host computer 11 may be connected with a hundred of semiconductor device manufacturing apparatuses 12. It should be noted that in the communication monitoring system 30 of the embodiment, any network other than the Ethernet 13 can be used.

The host computer 11 and the semiconductor device manufacturing apparatus 12 carries out SEMI standard based HSMS (HIGH-SPEED SECS MESSAGE SERVICES) communication through the Ethernet 13. The HSMS communication is equivalent to the SEMI standard based TCP/IP communication.

On the Ethernet 13, the bidirectional communication between the host computer 11 and the semiconductor device manufacturing apparatus 12 is carried out. Also, only communication between the host computer 11 and the semiconductor device manufacturing apparatus 12 is carried out on the Ethernet 13. Any communication other than the communication between the host computer 11 and the semiconductor device manufacturing apparatus 12 is not carried out, and the communication on the Ethernet 13 is limited to the SEMI standard based HSMS communication.

The outline of the operation procedure of the communication monitoring system 30 will be described.

\mathring{1} The HSMS network monitoring apparatus 20 takes and holds therein communication packets between the host computer 11 and the semiconductor device manufacturing apparatus 12 automatically.

\mathring{2} The HSMS network monitoring apparatus 20 always takes therein the communication packets between the host computer 11 and the semiconductor device manufacturing apparatus 12 and compares the taken-in packets with the held data automatically.

\mathring{3} When it is detected that a fault has occurred, as the result of the comparison of the above \mathring{2}, the HSMS network monitoring apparatus 20 automatically carries out analysis to determine which part is extraordinary.

According to the communication monitoring system 30 in the embodiment, it is possible to quickly detect of the fault and to analyze a reason for the fault, even if the host computer 11 is downed for the reason. Also, it is possible to detect the fault when the communication fault has occurred, and to analyze whether there is not a problem in a communication protocol, a communication sequence, a data format, and data. This is because the HSMS network monitoring apparatus 20 exists on the same network 13 as the host computer 11 and the semiconductor device manufacturing apparatus 12, and takes therein all the communication packets which flow on the network 13. Also, this is because it is possible to store all the communication data and to compare the taken-in data with the past data in the HSMS network monitoring apparatus 20.

Next, the function of HSMS network monitoring apparatus 20 will be described.

The HSMS network monitoring apparatus 20 has the following functions of (1) to (4):

(1) The fault detection and analysis function of the communications protocol;

(2) The fault detection and analysis function of the communication sequence;

(3) The fault detection and analysis function of the data format; and

(4) The fault detection and analysis function of the data.

(1) The HSMS network monitoring apparatus 20 has the fault detection and an analysis function of the communications protocol through the comparison with the stored data.

The HSMS network monitoring apparatus 20 stores a normal communications protocol in the past between the host computer 11 and the semiconductor device manufacturing apparatus 12. Each time the communication is newly carried out and a new communication packet is taken therein, the communications protocol of the taken-in communication packet is compared with the stored communication protocol. When both is different as the result of the comparison, the HSMS network monitoring apparatus 20 detects a protocol fault and analyzes how the communication protocol of the taken-in communication packet is different from the stored communications protocol in the normal state. Various methods can be used as an analyzing method, which is not limited in the embodiment.

(2) The HSMS network monitoring apparatus 20 has the fault detection and an analysis function of the communication sequence by the comparison with the stored data.

The HSMS network monitoring apparatus 20 stores a normal communication sequence in the past between the host computer 11 and the semiconductor device manufacturing apparatus 12. Each time the communication is newly carried and a new communication packet is taken therein, the communication sequence of the taken-in communication packet is compared with the stored communication sequence. When both is different as the result of the comparison, the HSMS network monitoring apparatus 20 detects a sequence fault and analyzes how the communication sequence of the taken-in communication packet is different from the stored communications sequence in the normal state. Various methods can be used as an analyzing method, which is not limited in the embodiment.

(3) The HSMS network monitoring apparatus 20 has the fault detection and an analysis function of the data format by the comparison with the stored data.

The HSMS network monitoring apparatus 20 stores a normal data format in the past between the host computer 11 and the semiconductor device manufacturing apparatus 12. Each time the communication is newly carried and a new communication packet is taken therein, the data format of the taken-in communication packet is compared with the stored data format. When both is different as the result of the comparison, the HSMS network monitoring apparatus 20 detects a data format fault and analyzes how the data format of the taken-in communication packet is different from the stored data format at the normal time. Various methods can be used as an analyzing method, which is not limited in the embodiment.

(4) The HSMS network monitoring apparatus 20 has the fault detection and analysis function of the data by the comparison with the stored data.

The HSMS network monitoring apparatus 20 can carry out the fault detection of the host computer 11 based on the fault detection of the data. The fault detection of the host computer 11 will be described below.

That is, the HSMS network monitoring apparatus 20 takes therein the data transmitted from the host computer 11 to the semiconductor device manufacturing apparatus 12, and stores and compares with the stored data every time the communication is newly carried. As the result, when both are different, the HSMS network monitoring apparatus 20 can detect that extraordinary data has been transmitted from the host computer 11 to the semiconductor device manufacturing apparatus 12. With this, it is possible to detect that the host computer 11 is fault (extraordinary event).

As seen from the communication sequence of the HSMS communication to be described later, the data transmitted from the semiconductor device manufacturing apparatus 12 to the host computer 11 differs if the lot (wafers) processed by the semiconductor device manufacturing apparatus 12 is changed. Therefore, the HSMS network monitoring apparatus 20 is difficult to distinguish whether the data is extraordinary data or normal data, even if both are different as the result of the comparison between the past data and the newly taken-in data.

On the other hand, most of the data transmitted from the host computer 11 to the semiconductor device manufacturing apparatus 12 are reception messages. The data content of the reception message is unrelated to the change of the lot. Therefore, as the result of the comparison between the past data and the newly taken-in data which has been transmitted from the host computer 11 to the semiconductor device manufacturing apparatus 12, when both are different, the HSMS network monitoring apparatus 20 is possible to distinguish whether the data is extraordinary. As a result, as mentioned above, the HSMS network monitoring apparatus 20 can detect the fault of the host computer 11 based on data itself.

In the conventional system 50, when the host computer 51 or the semiconductor device manufacturing apparatus 52 has been downed, the communication log recorded in the host computer 51 or the semiconductor device manufacturing apparatus 52 could not be taken out. On the other hand, in this embodiment, the communication log can be taken out because communication packets are recorded in the HSMS network monitoring apparatus 20, when the host computer 11 and/or the semiconductor device manufacturing apparatus 12 are downed.

Moreover, the HSMS network monitoring apparatus 20 detects and analyzes an HSMS communication traffic quantity on the Ethernet 13.

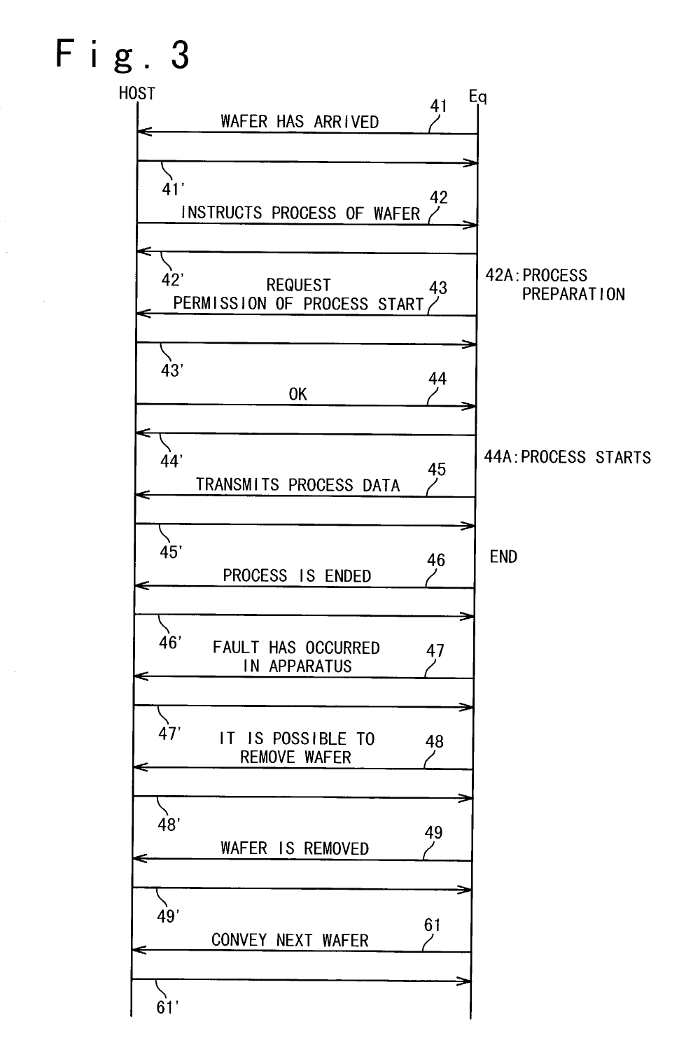

Next, a communication sequence of the HSMS communication will be described with reference to FIG. 3.

First, as shown in the code 41, the semiconductor device manufacturing apparatus 12 transmits a message packet of “a wafer has reached” to the host computer 11. Next, as shown in the code 41′, the host computer 11 transmits a message packet indicating the reception of the message packet of the code 41 to the semiconductor device manufacturing apparatus 12.

Next, as shown in the code 42, the host computer 11 transmits a message packet indicating a process instruction of the wafer to the semiconductor device manufacturing apparatus 12. Next, as shown in the code 42′, the semiconductor device manufacturing apparatus 12 transmits a message packet indicating the reception of the message packet of the code 42 to the host computer 11.

The semiconductor device manufacturing apparatus 12 receives a message packet indicating the code 42, and prepares the process of the wafer, as shown by the code 42A. As shown in code 43, when the preparation of the process ends, the semiconductor device manufacturing apparatus 12 transmits a message packet indicating a request of process start to the host computer 11. Next, as shown by the code 43′, the host computer 11 transmits a message packet indicating the reception of the message packet of the code 43 to the semiconductor device manufacturing apparatus 12.

Next, as shown by the code 44, the host computer 11 receives a message packet indicating of inquiry of the code 43 and transmits a message packet indicating “permission to start the process” to the semiconductor device manufacturing apparatus 12. Next, as shown by the code 44′, the semiconductor device manufacturing apparatus 12 transmits a message packet indicating the reception of the message packet of code 44 to the host computer 11. After that, as shown by the code 44A, the semiconductor device manufacturing apparatus 12 starts the process actually.

Next, the semiconductor device manufacturing apparatus 12 transmits a message packet indicating process data showing the process result to the host computer 11, as shown by the code 45. Next, as shown by the code 45′, the host computer 11 transmits a message packet indicating the reception of the message packet of the code 45 to the semiconductor device manufacturing apparatus 12.

Next, as shown in code 46, when the semiconductor device manufacturing apparatus 12 ends the whole of process instructed by the message of the code 42, the apparatus 12 transmits a message packet indicating the status of “process is ended” to the host computer 11. Next, as shown by the code 46′, the host computer 11 transmits a message packet indicating the reception of the message packet of code 46 to the semiconductor device manufacturing apparatus 12.

Also, as shown in code 47, the semiconductor device manufacturing apparatus 12 transmits a message packet indicating “a fault has occurred in the semiconductor device manufacturing apparatus 12” to the host computer 11 with no delay, when detecting that the fault (trouble) has occurred in the semiconductor device manufacturing apparatus 12 irrespective of the timings such as the way of the process, the preparation step of the process 42A, the removal state of the wafer. Next, as shown by the code 47′, the host computer 11 transmits a message packet indicating the reception of the message of code 47 to the semiconductor device manufacturing apparatus 12.

After that, as shown by the code 48, the semiconductor device manufacturing apparatus 12 transmits a message packet indicating that “the wafer can be removed”, to the host computer 11. As shown by the code 48′, the host computer 11 transmits a message packet indicating the reception of the message of code 48 to the semiconductor device manufacturing apparatus 12. When the removal of the wafer is automatically carried out, the instruction to remove the wafer is transmitted to a wafer removal machine at this timing.

After that, as shown by the code 49, the semiconductor device manufacturing apparatus 12 transmits a message packet indicating that “the wafer has been removed”, to the host computer 11. As shown by the code 49′, the host computer 11 transmits a message packet indicating the reception of the message of code 49 to the semiconductor device manufacturing apparatus 12.

After that, as shown by the code 61, the semiconductor device manufacturing apparatus 12 transmits to the host computer 11 a message packet indicating that “the next wafer should be brought”. As shown by the code 61′, the host computer 11 transmits a message packet indicating the reception of the message of code 61 to the semiconductor device manufacturing apparatus 12.

It should be noted that the communication sequence of FIG. 3 is not changed even if the wafer (the lot) to treat changes.

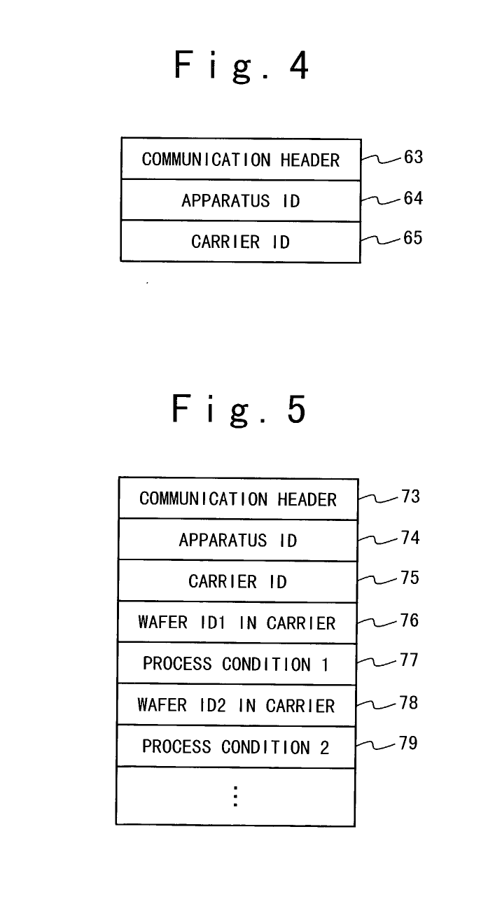

Next, a data format of the HSMS communication will be described with reference to FIG. 4 and FIG. 5.

FIG. 4 shows a data format when the communication shown by the code 41 is carried out. The message packet in the communication of the code 41 contains a communication header section 63, an apparatus ID section 64 and a carrier ID section 65.

The communication header section 63 contains a code for specifying a communication protocol, an address of itself (semiconductor device manufacturing apparatus 12), an address of the communication destination end (the host computer 11), and a kind of the message (whether the message is the message of the code 41 or the message of the code 43).

The ID of the semiconductor device manufacturing apparatus 12 is described in the apparatus ID section 64.

The ID of a box (carrier) in which the wafer to be processed from now is contained is described in the carrier ID section 65.

It should be noted that as far as the semiconductor device manufacturing apparatus 12 is identical, the address of the semiconductor device manufacturing apparatus 12 which is described in the communication header section 63 and the ID of the semiconductor device manufacturing apparatus 12 which is described in the apparatus ID section 64 has one-to-one correspondence.

FIG. 5 shows the data format when the communication shown by the code 42 is carried out. The message packet in the communication of the code 42 contains a communication header section 73, an apparatus ID section 74, a carrier ID section 75, a first in-carrier wafer ID section 76, a first process condition section 77, a second in-carrier wafer ID section 78, and a second process condition section 79.

The communication header section 73 contains a code for specifying a communications protocol, an address of it (host computer 11), an address of a communication destination end (semiconductor device manufacturing apparatus 12), and a kind of the message.

In the apparatus ID section 74 is written the ID of the semiconductor device manufacturing apparatus 12 as the communication destination end.

In the carrier ID section 75 is written the ID of the carrier in which the wafer to be processed is contained.

The ID of the first wafer to be handled in the communication is described in the first in-carrier wafer ID section 76.

The ID of a recipe to show a process content to the above first wafer and a recipe content (the process content) is described in the first process condition section 77.

The ID of the second wafer to be handled in the communication is described in the in-carrier second wafer ID section 78.

The ID of the recipe to shows a process content to the above second wafer and a recipe content is described in the second process condition section 79.

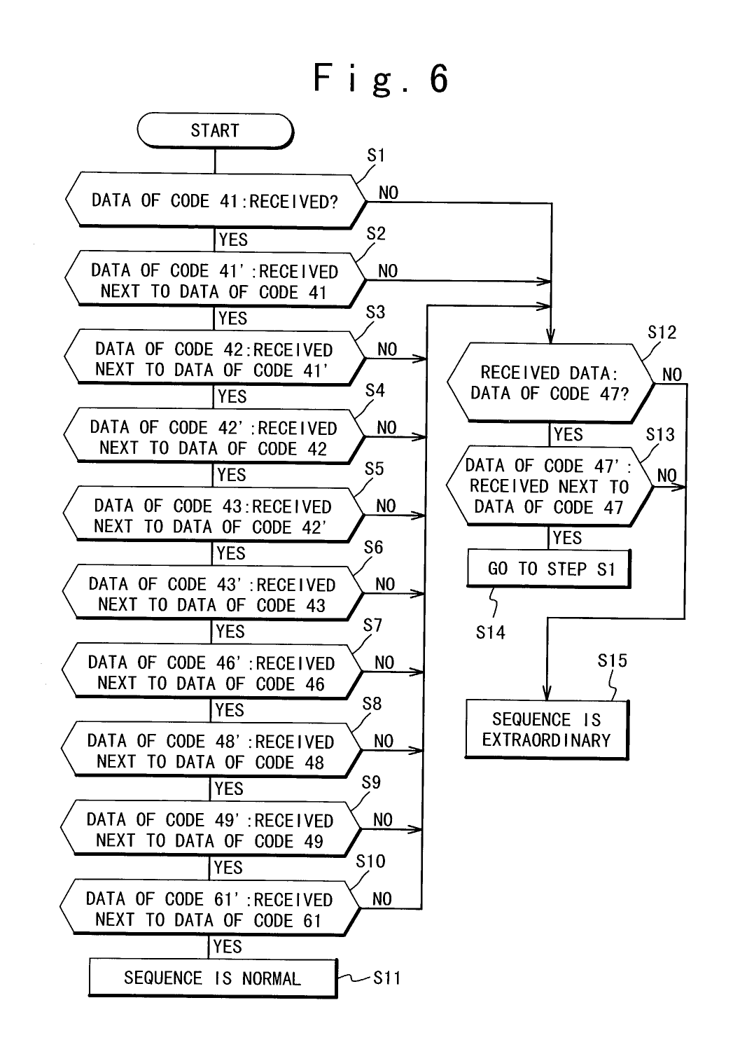

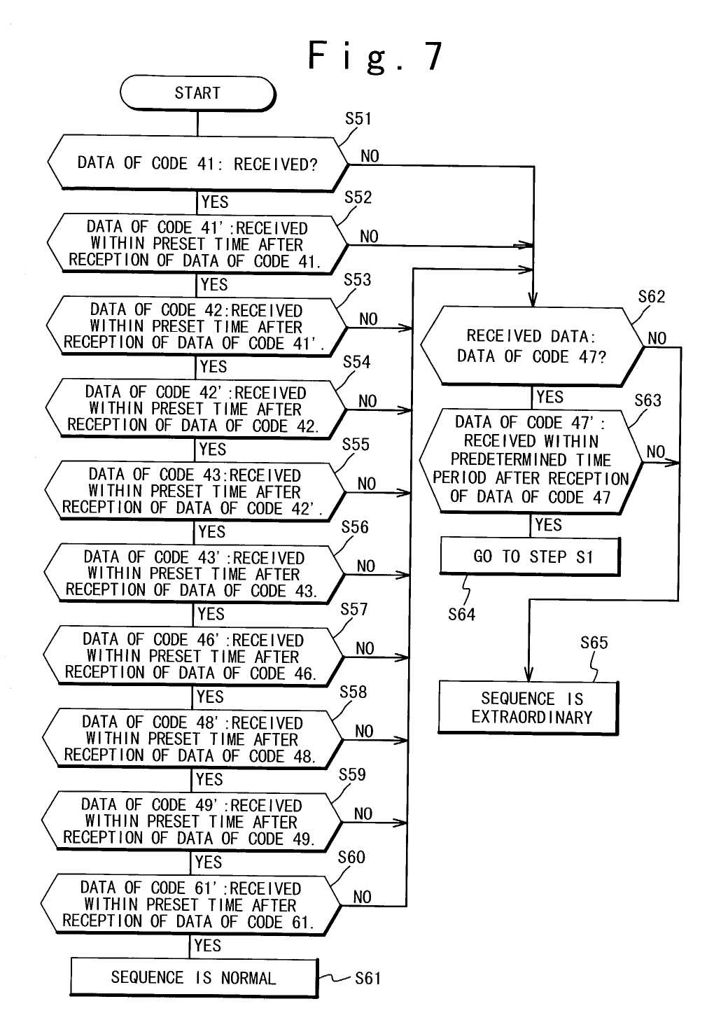

Next, the operation when the HSMS network monitoring apparatus 20 carries out the fault detection of the communication sequence will be described with reference to FIG. 6 and FIG. 7.

The HSMS network monitoring apparatus 20 takes therein all the HSMS communication packets on the Ethernet 13 and stores the taken-in packet. The HSMS network monitoring apparatus 20 compares data of the stored packet with various types of the stored data every time the new communication is carried out after that. The HSMS network monitoring apparatus 20 detects the fault of the communication sequence, when 28 the communication is not carried out in the same manner as the stored data (the communication sequence shown in FIG. 3), as the result of the comparison. The HSMS network monitoring apparatus 20 analyzes the extraordinary content, and detects the fault of the host computer 11 or the semiconductor device manufacturing apparatus 12.

In the above-mentioned case, the HSMS network monitoring apparatus 20 carries out the operation shown in FIG. 6, specifically.

First, the HSMS network monitoring apparatus 20 determines whether the packet of the code 41 has been received (whether or not the data is taken in), as shown at a step S1. If the HSMS network monitoring apparatus 20 has been received the packet of the code 41 as a result of the determination of the step Si, the control flow advances to a step S2.

At the step S2, the HSMS network monitoring apparatus 20 determines whether or not the packet of the code 41′ has been received immediately after the packet of the code 41. If the HSMS network monitoring apparatus 20 has been received the packet of the code 41′ as the result of the determination of the step S2, the control flow advances to a step S3.

At the step S3, the HSMS network monitoring apparatus 20 determines whether or not the packet of the code 42 immediately after the packet of the code 41′ has been received.

The HSMS network monitoring apparatus 20 carries out the steps to a step S10 in the same way, and determines that the communication sequence is normal (Step S11) if the packet of the code 61′ immediately after the packet of the code 61 has been received.

On the other hand, if the HSMS network monitoring apparatus 20 has not received the packet of the code 41 as a result of the determination of the step S1, the control flow advances to a step S12.

At the step S12, the HSMS network monitoring apparatus 20 determines whether or not the received packet is the data of the code 47. If the HSMS network monitoring apparatus 20 has received the packet of the code 47 as a result of the determination of the step S12, the control flow advances to a step S13.

At the step S13, the HSMS network monitoring apparatus 20 determines whether or not the HSMS network monitoring apparatus 20 has been received the packet of the code 47′ immediately after the packet of the code 47. If the HSMS network monitoring apparatus 20 has been received the data of the code 47′ as a result of the determination of the step S13, the control flow advances or returns to the step S1 (Step S14).

If the HSMS network monitoring apparatus 20 has not received the packet of the code 47 as a result of the determination of the step S12, the HSMS network monitoring apparatus 20 determines that the communication sequence is extraordinary (Step S15). Also, if the HSMS network monitoring apparatus 20 has not received the data of the code 47′ as a result of the determination of the step S13, the HSMS network monitoring apparatus 20 determines that the communication sequence is extraordinary (Step S15).

Also, if the HSMS network monitoring apparatus 20 has not received the packet of the code 41′ as a result of the determination of step S2, the control flow advances to the step S12. In the same way, if the HSMS network monitoring apparatus 20 has not received the packet of the code 42 as a result of the determination of the step S3, the control flow advances to the step S12. Hereinafter, similarly, if the HSMS network monitoring apparatus 20 has not received the packets of the codes 42′ to 61′ as a result of the determination of the steps S4 to 10, the control flow advances to step S12.

The HSMS network monitoring apparatus 20 may carry out the operation of FIG. 7 in place of the operation of FIG. 5.

First, the HSMS network monitoring apparatus 20 determines whether or not the HSMS network monitoring apparatus 20 has been received the packet of the code 41, as shown at a step S51. If the HSMS network monitoring apparatus 20 has received the packet of the code 41 as a result of the determination of the step S51, the control flow advances to a step S52.

At the step S52, the HSMS network monitoring apparatus 20 determines whether or not the HSMS network monitoring apparatus 20 has received the packet of the code 41′ within the predetermined time after the reception of the packet of the code 41. If the HSMS network monitoring apparatus 20 has received the packet of the code 41′ within the predetermined time as a result of the determination of the step S51, the control flow advances to a step S53.

At the step S53, the HSMS network monitoring apparatus 20 determines whether or not the HSMS network monitoring apparatus 20 has received the packet of the code 42 within the predetermined time after the reception of the data of the code 41′. It should be noted that the predetermined time of the step S53 and the predetermined time of the step S52 might be different times (Hereinafter, the times are same).

The HSMS network monitoring apparatus 20 carries out the steps up to a step S60 in the same way, hereinafter. If the HSMS network monitoring apparatus 20 has received the packet of the code 61′ within the predetermined time after the reception of the packet of the code 61, the HSMS network monitoring apparatus 20 determines that the communication sequence is normal (Step S61).

On the other hand, if the HSMS network monitoring apparatus 20 has not received the packet of the code 41 as a result of the determination of the step S51, the control flow advances to a step S62.

At the step S62, the HSMS network monitoring apparatus 20 determines whether or not the received packet is the packet of the code 47. If the HSMS network monitoring apparatus 20 has received the packet of the code 47 as a result of the determination of the step S62, the control flow advances to a step S63.

At the step S63, the HSMS network monitoring apparatus 20 determines whether or not the HSMS network monitoring apparatus 20 has received the packet of the code 47′ within the predetermined time after the reception of the data of the code 47. If the HSMS network monitoring apparatus 20 has received the packet of the code 47′ as a result of the determination of the step S63, the control flow advances or returns to the step S51 (Step S64).

If the HSMS network monitoring apparatus 20 has not received the packet of the code 47 as a result of the determination of the step S62, the HSMS network monitoring apparatus 20 determines that the communication sequence is extraordinary (Step S65).

Also, if the HSMS network monitoring apparatus 20 has not received the packet of the code 47′ as a result of the determination of the step S63, the HSMS network monitoring apparatus 20 determines that the communication sequence is extraordinary (Step S65)

Also, if the HSMS network monitoring apparatus 20 has not received the packet of the code 41′ as a result of the determination of the step S52, the control flow advances to the step S62. In the same way, if the HSMS network monitoring apparatus 20 has not received the packet of the code 42 as a result of the determination of the step S53, the control flow advances to the step S62. Hereinafter, in the same way, if the HSMS network monitoring apparatus 20 has not received the packets of the codes 42′ to 61′ as a results of the determination of the steps S54 to 60, the control flow advances to the step S62.

Next, it is supposed that the process by the semiconductor device manufacturing apparatus 12 is started actually (44A) and the communication packet of the code 45 is transmitted from the semiconductor device manufacturing apparatus 12 to the host computer 11 on the process way, when the communication packet of the code 43 is not transmitted from the semiconductor device manufacturing apparatus 12 to the host computer 11. In this case, the HSMS network monitoring apparatus 20 detects a fault of the semiconductor device manufacturing apparatus 12, because the current communication sequence is different from the past communication sequence. Here, in the conventional case that there is not the HSMS network monitoring apparatus 20, the host computer 11 recognizes a communication error and does not carry out the reception of the communication packet of the code 45, when the communication packet of the code 45 is transmitted without transmitting the communication packet of the code 44. Therefore, the process fault of the semiconductor device manufacturing apparatus 12 is not sometimes left in the communication record of the host computer 11. On the other hand, the HSMS network monitoring apparatus 20 in this embodiment can detect the process fault of the semiconductor device manufacturing apparatus 12 surely through comparison with the past communication sequence.

Also, the HSMS network monitoring apparatus 20 can detect the fault of the communication sequence, when the communication packet of the code 43 has the content of “process is started” in a declaration form in which permission is not requested, in place of the above content of the inquiry form in which the permission of the process start is requested to the host computer 11. That is, when the communication packet of the process data of the code 45 is transmitted from the semiconductor device manufacturing apparatus 12 to the host computer 11, without the transmission of the communication packet of the code 43 with the content about the start of the process from the semiconductor device manufacturing apparatus 12 to the host computer 11, the HSMS network monitoring apparatus 20 can detect the fault of the communication sequence, because the current communication sequence is different from the past communication sequence.

A case where the host computer 11 cannot receive the above communication packet 43, because the host computer 11 is busy though the above communication packet 43 of “process is started” in the declaration form from the semiconductor device manufacturing apparatus 12 has been normally transmitted, will be described.

In this case, the host computer 11 receives the process data 45 next, irrespective that the host computer 11 has not received the communication packet 43, when the communication packet 43 is not the question form but is the declaration form, the communication packet 44 to give permission is not transmitted. In the conventional case that there is not the HSMS network monitoring apparatus 20, the host computer 51 recognizes a communication error and does not carry out the reception of the communication packet of the code 45, when the communication packet of the code 45 is transmitted in the state that the communication packet of the code 43 has not been received. In this embodiment, the HSMS network monitoring apparatus 20 recognizes that the communication packet 43 from the semiconductor device manufacturing apparatus 12 has been normally transmitted to the host computer 11, because the communication packet 43 is taken therein the HSMS network monitoring apparatus 20. Therefore, when the communication packet 45 is transmitted to the host computer 11 after that, and the communication packet 45 is taken therein by the HSMS network monitoring apparatus 20, the HSMS network monitoring apparatus 20 can instruct the host computer 11 to “receive the communication packet 45 and continue the subsequent process because the communication packet 45 is the communication packet of a normal communication sequence”.

Next, the case where the HSMS network monitoring apparatus 20 detects the fault of the data format will be described.

The HSMS network monitoring apparatus 20 takes therein all the HSMS communication packets on the Ethernet 13 and stores the taken-in packet. Then, the HSMS network monitoring apparatus 20 compares data of the stored packet with the stored data every time the new communication is carried out after that. The HSMS network monitoring apparatus 20 checks the number of bit or a kind of code (for example, the alphanumeric character only) of the data described in each of sections of the data format shown in FIG. 4 or FIG. 5. As the result of the comparison, the HSMS network monitoring apparatus 20 detects a fault of a data format, when the number of bit or a kind of code (for example, the alphanumeric character only) of the data described in each of sections of the data format shown in FIG. 4 or FIG. 5 is different from the data stored in the past. The HSMS network monitoring apparatus 20 detects the fault of the host computer 11 or the semiconductor device manufacturing apparatus 12 by analyzing the extraordinary content.

Next, the case where the HSMS network monitoring apparatus 20 detects a fault of the data will be described.

The HSMS network monitoring apparatus 20 checks the address of the semiconductor device manufacturing apparatus 12 and the apparatus ID of the semiconductor device manufacturing apparatus 12. Then, the HSMS network monitoring apparatus 20 detects the fault of the semiconductor device manufacturing apparatus 12 as a transmission destination end, because the data of the communication packet (for example, the message of the code 41) is extraordinary, when the address of the semiconductor device manufacturing apparatus 12 described in the communication header section 63 of the communication packet has no correspondence to the apparatus ID of the semiconductor device manufacturing apparatus 12 described in the apparatus ID section 64 of the same communication packet.

In the same way, the HSMS network monitoring apparatus 20 detects the fault of the host computer 11 as the transmission source end, because the data of the communication packet (for example, the message of the code 42) is extraordinary, when the address of the semiconductor device manufacturing apparatus 12 described in the communication header section 73 of the communication packet has no correspondence to the apparatus ID of the semiconductor device manufacturing apparatus 12 described in the apparatus ID section 74 of the same communication packet.

Moreover, the HSMS network monitoring apparatus 20 detects the fault of the host computer 11 or the semiconductor device manufacturing apparatus 12 as the transmission end, because the data of the communication packet is extraordinary, when the address in the communication header section 63 of FIG. 4 is not coincident with the address in the communication header section 73 of FIG. 5, when the apparatus ID section 64 is not coincident with the apparatus ID section 74, or when the carrier ID section 65 is not coincident with the carrier ID section 75, in one communication sequence.

Moreover, the HSMS network monitoring apparatus 20 detects the fault of the semiconductor device manufacturing apparatus 12 as the transmission end, because the data of the communication packet is extraordinary, when the wafer ID described in the communication packet shown by the code 43 in one communication sequence and the wafer ID described in the communication packet shown by the code 46 are different from each other.

As described above, in the communication monitoring system 30 of the embodiment, the operation to store a normal communication protocol, a normal communication sequence, a normal data format, normal data in the HSMS network monitoring apparatus 20 is not carried out. In this embodiment, the communication packets in the communication carried out between the host computer 11 and the semiconductor device manufacturing apparatus 12 are all taken therein by the HSMS network monitoring apparatus 20 and accumulated. A fault is detected through the comparison with the data of the communications protocol, the normal communication sequence, the normal data format, and the normal data of the communication normally carried out. The reason why the above system is used in the embodiment will be described below.

In the embodiment, the communication sequences (see FIG. 3) between the plurality of the host computers 11 and the plurality of semiconductor device manufacturing apparatuses 12 are different from each other. Therefore, if it is supposed that the normal communication sequences are stored in the HSMS network monitoring apparatus 20, there is a problem that the work steps increase.

In this point, in the embodiment, the HSMS network monitoring apparatus 20 stores all the communication packets in the communication carried out actually between the host computer 11 and the semiconductor device manufacturing apparatus 12 without any preliminary preparation. Then, the HSMS network monitoring apparatus 20 compares the stored data with the data of each newly taken communication packet based on the addresses of the communication source (the transmission end) and communication destination (the reception end) in each of the newly taken communication packets. Therefore, there is not a problem in increase of the above-mentioned work steps.

As described above, the HSMS network monitoring apparatus 20 stores the communication packets actually flowing on the Ethernet 13. In this case, however, when the normal communication packet and the normal communication sequence are stored once, it is not necessary to store the normal communication packet and the normal communication sequence which are the same contents as the stored data once again (or every time). Or, after storing the normal communication packet and the normal communication sequence once, the HSMS network monitoring apparatus 20 may store the communication packet and the communication sequence which have not been determined as a fault as a result of the above comparison to update (over-write) the already stored data every time.

According to the communication monitoring system of the present invention, it is possible to detect the fault of the communication with the semiconductor device manufacturing apparatus, even if the host computer is downed.

What is claimed is:

1. A communication monitoring system comprising:
a semiconductor device manufacturing apparatus connected with a network;
a host computer connected with said network, wherein said semiconductor device manufacturing apparatus and said host computer carry out a sequence of communications through said network about a process of said semiconductor device manufacturing apparatus; and
a monitoring unit connected with said network, takes therein a first set of packets of said first sequence of communications and a second set of packets of said second sequence of communications through said network between said semiconductor device manufacturing apparatus and said host computer, and determines whether said communication between of said semiconductor device manufacturing apparatus and said host computer is normal or defective, based on said packets of said first and second sets.

2. The communication monitoring system according to claim 1, wherein said monitoring unit compares an order of said packets of said first set and an order of said packets of said second set and determines whether said communication between of said semiconductor device manufacturing apparatus and said host computer is normal or defective, based on the comparison result of the order of said packets of said first set and the order of said packets of said second set.

3. The communication monitoring system according to claim 1, wherein when a first one of said packets of said second set which is transmitted from said semiconductor device manufacturing apparatus to said host computer in said second sequence of communications is determined to be normal but has been not received by said host computer, said monitoring unit instructs said host computer to receive a second one of said packets of said second set which is transmitted from said semiconductor device manufacturing apparatus to said host computer in said second sequence of communications through said network, immediately after the transmission of said first packet.

4. The communication monitoring system according to claim 3, wherein said monitoring unit further instructs said host computer to continue subsequent communications of said second sequence to the reception of said second packet.

5. The communication monitoring system according to claim 1, wherein said monitoring unit determines that said communication from one of said semiconductor device manufacturing apparatus and said host computer to the other is defective, when said first packet is transmitted from one of said semiconductor device manufacturing apparatus and said host computer to the other and then a third one, next to said first packet, of said packets of said second set is not transmitted from the other to said one through said network within a predetermined time from the transmission of said first packet.

6. The communication monitoring system according to claim 1, wherein each of said packets of said second set has a communication header containing an address of one of said semiconductor device manufacturing apparatus and said host computer as a source address and an address of the other as a destination address, and an apparatus ID for said semiconductor device manufacturing apparatus, and
said monitoring unit determines that said communication from one of said semiconductor device manufacturing apparatus and said host computer to the other is defective, when one of said source address and said destination address corresponding to said semiconductor device manufacturing apparatus does not correspond to said apparatus ID.

7. The communication monitoring system according to claim 1, wherein each of said packets of said second set has a communication header containing an address of one of said semiconductor device manufacturing apparatus and said host computer as a source address and an address of the other as a destination address, and an apparatus ID for said semiconductor device manufacturing apparatus, and
said monitoring unit determines that said communication from said host computer to said semiconductor device manufacturing apparatus is defective, when said destination addresses are not coincident with each other among said packets from said host computer to said semiconductor device manufacturing apparatus.

8. The communication monitoring system according to claim 1, wherein each of said packets of said second set has a communication header, an apparatus ID for said semiconductor device manufacturing apparatus, and a carrier ID of a carrier in which semiconductor wafers are accommodated, and
said monitoring unit determines that said communications of said second sequence are defective, when said carrier IDs are not coincident with each other among said packets of said second set.

9. The communication monitoring system according to claim 8, wherein some of said packets of said second set has a wafer ID in addition to the communication header, the apparatus ID, and the carrier ID, and
said monitoring unit determines that said communications of said second sequence are defective, when said wafer IDs are not coincident with each other among said some packets of said second set.

10. The communication monitoring system according to claim 1, wherein each of said communications of said second sequence are carried out in accordance with one of predetermined data formats, and
said monitoring unit determines that said sequence of said communications is defective, when data formats are not coincident with each other between corresponding two of said communications of said second sequence.

11. The communication monitoring system according to claim 1, wherein said monitoring unit stores said first set of said packets of said first sequence of said communications and discards said second set of said packets of said second sequence of said communications, after it is determined that said second sequence of said communications is normal.

12. The communication monitoring system according to claim 1, wherein said monitoring unit stores said first set of said packets of said first sequence of said communications, and updates each of said packets of said first set by a corresponding one of said packets of said second set of said second sequence of said communications, after it is determined that said second sequence of said communications is normal.

13. The communication monitoring system according to claim 1, wherein said communication between said semiconductor device manufacturing apparatus and said host computer is of HSMS (HIGH-SPEED SECS MESSAGE SERVICES) communication based on the SEMI standard.

14. A communication monitoring system comprising:
a semiconductor device manufacturing apparatus connected with a network;
a host computer connected with said network, wherein said semiconductor device manufacturing apparatus and said host computer carry out a sequence of communications through said network about a process of said semiconductor device manufacturing apparatus; and
a monitoring unit connected with said network, takes therein a first set of packets of said first sequence of communications and a second set of packets of said second sequence of communications through said network between said semiconductor device manufacturing apparatus and said host computer, an order of said packets of said first set and an order of said packets of said second set, compares said packets of said second set in at least one of a data format and data in each of said packets, and determines whether said communication between of said semiconductor device manufacturing apparatus and said host computer is normal or defective, based on the comparing results.

15. The communication monitoring system according to claim 14, wherein said monitoring unit further instructs said host computer to continue subsequent communications of said second sequence to the reception of said second packet.

16. The communication monitoring system according to claim 14, wherein said monitoring unit determines that said communication from one of said semiconductor device manufacturing apparatus and said host computer to the other is defective, when said first packet is transmitted from one of said semiconductor device manufacturing apparatus and said host computer to the other and then a third one, next to said first packet, of said packets of said second set is not transmitted from the other to said one through said network within a predetermined time from the transmission of said first packet.

17. The communication monitoring system according to claim 14, wherein each of said packets of said second set has a communication header containing an address of one of said semiconductor device manufacturing apparatus and said host computer as a source address and an address of the other as a destination address, and an apparatus ID for said semiconductor device manufacturing apparatus, and
said monitoring unit determines that said communication from one of said semiconductor device manufacturing apparatus and said host computer to the other is defective, when one of said source address and said destination address corresponding to said semiconductor device manufacturing apparatus does not correspond to said apparatus ID.

18. The communication monitoring system according to claim 14, wherein each of said packets of said second set has a communication header containing an address of one of said semiconductor device manufacturing apparatus and said host computer as a source address and an address of the other as a destination address, and an apparatus ID for said semiconductor device manufacturing apparatus, and
said monitoring unit determines that said communication from said host computer to said semiconductor device manufacturing apparatus is defective, when said destination addresses are not coincident with each other among said packets from said host computer to said semiconductor device manufacturing apparatus.

19. The communication monitoring system according to claim 14, wherein each of said packets of said second set has a communication header, an apparatus ID for said semiconductor device manufacturing apparatus, and a carrier ID of a carrier in which semiconductor wafers are accommodated, and
said monitoring unit determines that said communications of said second sequence are defective, when said carrier IDs are not coincident with each other among said packets of said second set.

20. The communication monitoring system according to claim 19, wherein some of said packets of said second set has a wafer ID in addition to the communication header, the apparatus ID, and the carrier ID, and
said monitoring unit determines that said communications of said second sequence are defective, when said wafer IDs are not coincident with each other among said some packets of said second set.
